(19) United States
(12) Patent Application Publication
(10) Pub. No.: US 2004/0098395 A1
(43) Pub. Date: May 20, 2004

(54) Self-organizing sensor network and method for providing self-organizing sensor network with knowledge data

(75) Inventor: Atsushi Hisano, San Jose, CA (US)

Correspondence Address: BEYER WEAVER & THOMAS LLP, P.O. BOX 778, BERKELEY, CA, 94704-0778, US

(73) Assignee: OMRON Corporation

(21) Appl. No.: 10/370,168

(22) Filed: Feb. 19, 2003

Related U.S. Application Data
(60) Provisional application No. 60/427,405, filed on Nov. 18, 2002.

(51) Int. Cl. G06F 7/00

(52) U.S. Cl. 707/100

(57) ABSTRACT

A knowledge information extracting device includes a first storing means for storing a type of information to be output with respect to a designated information processing device, and a second storing means for storing a type of information to be input with respect to the information processing device. A knowledge information database access means is capable of accessing a knowledge information database containing a plurality of rules, each of the rules including a condition part and a conclusion part. A rile extracting means is capable of extracting at least one rule having the condition part corresponding to the type of information to be input, and the conclusion part corresponding to the type of information to be output, by using the knowledge information database access means. A knowledge information storing means is capable of storing the at least one rule extracted by the rule extracting means by associating the at least one rule with the information processing device.

### BACKGROUND OF THE INVENTION

This invention is related to a sensor network, and more specifically to a self-organization sensor network capable of flexibly switching sensing operations using knowledge data.

Security systems which give warning based on information from a plurality of sensors have been developed recently. For example, burglary alert systems which warn emergencies in a remote location with motion sensors for detecting vibration installed around a house have been widely used.

Various techniques for message transfer on a network have been developed. Japanese Laid-Open Patent Publication 2000-315974, and U.S. Pat. No. 6,028,857 describe a mechanism for automatically set communication paths between wireless communication nodes. In Japanese Patent Nos. 3312141 and 2605828, a command or a query to a upper-level node is parsed, and in order to obtain information about the parsed portion, further command or query will be transmitted to lower-level node.

However, according to the prior art including the above-identified references, it is not possible to efficiently set a role or a function of each node.

### SUMMARY OF THE INVENTION

The invention is conceived to solve the above-mentioned problems. In one aspect, wireless communication nodes (hereinafter, referred to as “nodes”) having sensors are positioned in a sensing object area depending on the sensing purposes. Thus, a communication network is automatically formed by the nodes' self-organization. Then, knowledge data necessary for the nodes is automatically downloaded from a center facility, and a sensor network which organically couples sensing functions associated with the nodes is constructed. In another aspect, a sensing model for converting to condition data a signal detected by a sensor associated with a node can be tuned. Thus, the recognition rate by the constructed sensor network can be improved. In still another aspect, a matrix of distances between the nodes forming the sensor network can be monitored at the center and each node. Thus, based on a displacement of each node forming the sensor network, or information regarding whether communication to a node is possible or not, not only the sensing object, but also an attack against the sensor network itself can be detected, thus providing advantages in applications for a security system.

An intelligent self-organizing wireless sensor network which couples many wireless communication nodes having a query parsing function is provided. When a sensing purpose represented as a query is input to a control node of the network, many lower-level queries are generated by rule-type knowledge data stored in the control node to answer the query. Then, a lower-level query is transmitted from the control node to a node having a suitable function at a suitable location. In order to answer the query, a node which has received the lower-level query attempts to generate further a lower-level query by using rule-type knowledge data stored in the node, and to obtain sensing information for answering the query by using an output of the sensor provided by the node. Once the sensing information necessary for answering the query is obtained by performing this query parsing process, the node generates an answer, and transmits the answer back to the node which has transmitted the query to the node. Answers are forwarded toward the control node from various areas of the network following a reverse process of a process in which queries are dispersed in the network while they are parsed. The rule-type knowledge data necessary for this processing are downloaded to each node after being selected from knowledge database in a M2M center based on a type of a sensor provided by each node, a type of information output by each node, a type of an installed object for each node, and types of neighboring nodes. Also, the matrix of distances between the nodes is monitored as data representing the network condition. Thus, an attack against the sensor network itself, and transformation of an object equipped with the sensor network can be detected. Therefore, since this system can deal with a situation in which the sensing purpose varies, and can detect an attack against the sensor network itself, the system is suitable for providing a general-purpose, highly sophisticated security system.

### BRIEF DESCRIPTION OF THE DRAWINGS

FIG. 1 is a diagram for illustrating overall operation of a system according to an embodiment of the present invention.

FIG. 2 is a diagram for illustrating a structure of a node according to an embodiment of the present invention.

FIG. 3 is a diagram illustrating an M2M (machine-to-machine) system according to an embodiment of the present invention.

FIG. 4 is a diagram illustrating a process for obtaining condition data “Condition” according to an embodiment of the present invention.

FIG. 5 is a diagram illustrating a process for generating an attribute for each node according to an embodiment of the present invention.

FIG. 6 is a diagram illustrating a data format of a message according to an embodiment of the present invention.

FIG. 7 is a diagram illustrating a received message list provided in each node according to an embodiment of the present invention.

FIG. 8 is a diagram illustrating a neighboring node list provided in each node according to an embodiment of the present invention.

FIG. 9 is a diagram illustrating a format of data representing attribute information of each node according to an embodiment of the present invention.

FIG. 10 is a diagram illustrating a process of downloading knowledge data to each node according to an embodiment of the present invention.

FIG. 11 is a diagram illustrating a node data, and a fingerprint data generated according to an embodiment of the present invention.

FIG. 12 is a diagram illustrating a relationship between a certain node and nodes locating its neighborhood according to an embodiment of the present invention.

FIG. 13 is a diagram illustrating neighboring node attribute data for the nodes N0-N4 obtained by the M2M center using the system structure information according to an embodiment of the present invention.

FIG. 14 is a diagram illustrating rules stored in the knowledge database according to an embodiment of the present invention.

FIG. 15 is a diagram illustrating tuning at the M2M center, and downloading of the sensing model according to an embodiment of the present invention.

FIG. 16 is a diagram illustrating the system's operation according to an embodiment of the present invention.

FIG. 17 illustrates a typical computer system used for implementing some embodiments of the present invention.

### DETAILED DESCRIPTION OF SPECIFIC EMBODIMENTS

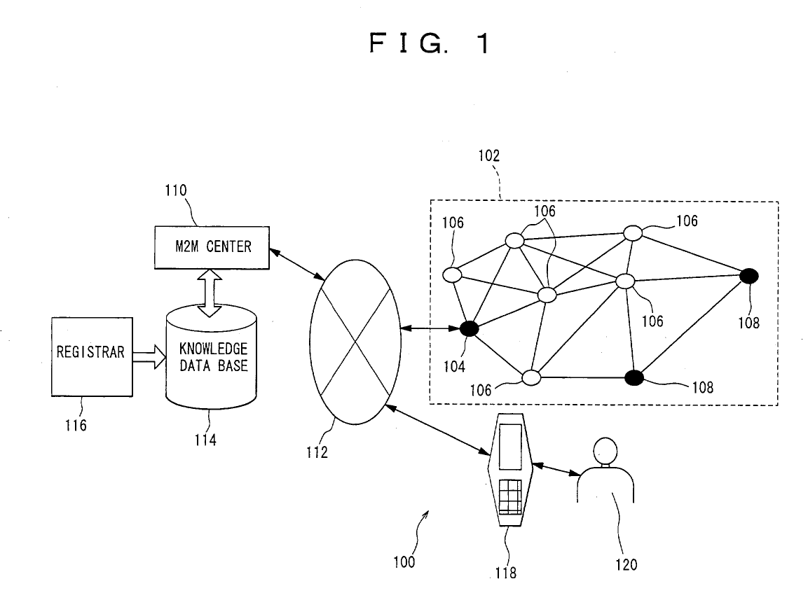

1. Summary of the System FIG. 1 is a diagram for illustrating overall operation of a system 100 (“AI-Hagoromo System,” referred to as the abbreviation “AHS”) according to an embodiment of the present invention.

1.1 Features of the AHS

The AHS 100 provides a self-organizing wireless communication network 102 (hereinafter “Hagoromo”) which monitors its own network structure. This Hagoromo network 102 includes a plurality of wireless nodes 104, 106 and 108. Each node has a sensor, and a memory storing knowledge data. Hagoromo processes information sensed by each node in the distributed network 102 using knowledge data while exchanging information with other nodes. As a result, the network as a whole performs a sensing function. That is, it constitutes an intelligent sensor network, or an intelligent Hagoromo system. Features of the AHS 100 include:

(1) Sensor network for monitoring its own network structure (i.e., “fingerprint” described later). Thus, not only sensing an object or an object area, but also an attack against the network itself, or substitution of a fake one for a real node can be detected. In other words, it constitutes a sensor network with high security level.

(2) Capable of detecting an object's displacement, transformation, and substitution as a variation of the network structure (“fingerprint”) even when each wireless communication node constituting the sensor network has no sensor, or a sensor provided by the node has not functioned due to being destroyed.

(3) Knowledge data or a sensor is distributed to each node, and queries given to each node can be varied based on a purpose given to the control node (a type of information to be output). Also at each node, among the provided knowledge data, knowledge data which is actually used dynamically varies based on its neighboring nodes' conditions (communication capability, a type of the output information), and a query given to the node (a type of information to be output). Thus, it is capable of performing an operation flexibly as a whole system for achieving the purpose given to the control node; without developing a new system even when a purpose given to the control node (a type of information to be output) is changed, or even when a part of the system has been failed by utilizing other live functions. That is, it constitutes a robust, general-purpose system.

(4) The latest knowledge data with improved performance or functions can be used at each node since knowledge data can be downloaded from the M2M center to each node of the Hagoromo. Also, tuning of a sensing model of each mode is performed by the M2M center, and the tuned sensing model is downloaded to each node. Thus, each node can enjoy the benefit as soon as improvement of tuning method is obtained by the M2M center.

1.2 Summary of AHS

The AHS is a general-purpose sensor network in which combination of information exchange between nodes changes, or a node function changes by changing knowledge data used for each node based on the purpose of the operation. An overall operation of the AHS is as follows:

STEP 1: Position nodes at a sensing object or a sensing area in a condition in which instructions for installing the nodes 104, 106 and 108 can be received from an M2M center 110 by using an install tool.

STEP 2: Each node generates its attributes.

STEP 3: Then, the wireless communication sensor network including each node 102 (i.e., “Hagoromo”) generates system structure information by self-organization, and transmits “fingerprint” from the control node 104 to each node 106 and 108 so that each node individually stores its “fingerprint” from the system structure information. Later, it transmits the system structure information to the M2M center 110 via a communication network 112.

STEP 4: The M2M center 110 extracts from a knowledge database 114 knowledge data which each node of the Hagoromo 102 should retain based on the system structure information and an output information type of the control node 104 in the Hagoromo, and receives the knowledge data.

STEP 5: The M2M center 110 transfers the knowledge data received from the knowledge database 114 to the nodes 106 and 108 via the communication network 112 and the control node 114. In other words, each node downloads its knowledge data.

STEP 6: Operate the system 100 based on the knowledge data, and perform tuning of the sensing models by the M2M center 110.

STEP 7: The M2M center 110 transfers the tuned sensing models to the nodes 106 and 108 via the communication network 112 and the control node 114. That is, it downloads the sensing model to each node. Knowledge data for the control node is downloaded in a similar manner.

STEP 8: The system 102 begins actual operation.

The M2M center 110 is capable of accessing the knowledge database 114 which stores various knowledge data usable for each node in the Hagoromo 102. The knowledge database 114 can be integrated with the M2M center 110, or can be provided in a separate unit. Alternatively, the knowledge database can be provided in a remote location. The knowledge database 114 is directly or indirectly (e.g., from a remote location) manageable by a registrar 116 (i.e., a system user). That is, the registrar 116 may manage it by remotely accessing via the M2M center 110 instead of directly managing the knowledge database.

The Hagoromo 102 includes the following three wireless nodes: the control node 104, the fixed node 106, and the mobile node 108. Each node has a wireless communication function, a distance measuring function for measuring a distance with other nodes, and a communication function for exchanging messages with other nodes. In addition, each node has a function for setting a node number by itself using self-organization function, a function for relaying messages to other nodes, and a function for transmitting data of the distance between the node and neighboring nodes to the control node.

The control node 104 generates “fingerprint” (described later) which represents a structure of the network 102 by combining information of “distances to neighboring nodes with respect to the node” received from each node; and transmits the fingerprint to the M2M center 110 periodically, or when the fingerprint presents a change. Also, the control node 104 modifies a signal sensed at each node location by using sensors distributed at each node constituting the Hagoromo 102, and knowledge data; and performs information processing of synthesis with a signal sensed by another node. Thus, the control node 104 not only combines and relays sensor outputs, but also has information sensing function of locally performing high-level recognition and decision. Also, not only the control node, but also each node in the network individually shares the process of recognition/decision using knowledge data.

The fixed node 106 is a node in which a condition that the node's location is fixed with respect to the control node is deemed to be a normal condition. For example, when the control object is a house, a fixed node can be installed on a wall or the ground.

The mobile node 108 is a node in which the node's location is deemed to be movable with respect to the control node. For the mobile node, a condition that the position is fixed is deemed to be normal during the alert mode, and a condition that the position is mobile is deemed to be normal during the non-alert mode.

An install tool 118 is a tool for instructing an install operator by the M2M center 110 on installation and tuning for a node of the Hagoromo 102. That is, the install tool 118 interfaces a user who installs and tunes the Hagoromo nodes 104, 106 and 108 with the M2M center. In an embodiment, the install tool can be implemented as a cellular phone or a cordless telephone, thereby reducing cost. A cellular phone in which the tool has been installed may display the information regarding installation (e.g., install instructions) from the M2M center 110. For example, in an embodiment, node install assistance software which is described by, e.g., Java can be used after being download. The install tool may be connected to the M2M center via a wireless or wired communication network, and may be used by an operator 120 at an install site of the Hagoromo.

In one embodiment, the install tool can be implemented as a software installed in a laptop computer having a wireless interface. In such a case, the tool communicates with the M2M center via the wireless interface of the computer in order to receive instructions necessary for the install and tuning.

The M2M center performs monitoring of the fingerprint of the Hagoromo, downloading of knowledge data to each node in the Hagoromo, tuning of the sensing model of each node in the Hagoromo and downloading of the tuned sensing model to each node, instructing the purpose (output information type) to the control node in the Hagoromo, receiving a report from the control node, and transmitting of instruction information for node installation of the Hagoromo. Therefore, the M2M center used for an embodiment of the present invention can be implemented by, for example, a general-purpose server, and a software running on the server. In another embodiment, the M2M center also may be implemented by a mobile computer provided with a wireless interface so that the M2M center itself is movable.

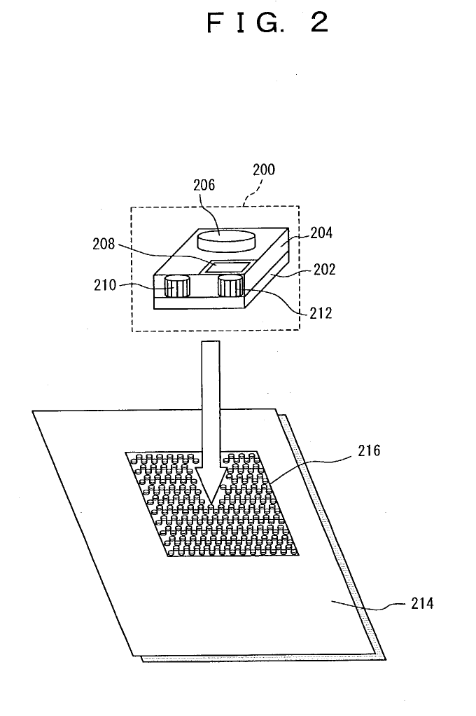

FIG. 2 is a diagram for illustrating a structure of a node 200, and its use. In one embodiment, the node 200 has an attachment portion 202, information sensing portion 204, and a localizer 206. These portions may comprise a three-layer structure. As understood by those skilled in the art, the physical structure of the node 200 is not limited to this three-layer structure. For example, it may be integrated into a single unit implemented by a hybrid integrated circuit (IC) or a thin-film INTEGRATED CIRCUIT. The information sensing portion 204 has, for example, a display device 208, and switches 210 and 212 for inputting data.

In one embodiment, the localizer 206 measures the distances between the nodes 104, 106 and 108. As the localizer 206, a localizer manufactured by [symbol] ther Wire & Location, Inc. (http://www.aetherwire.com/Aether_Wire/Rapid_Acquisition_for_UWB_Transceiver s.pdf) may be used. Such a localizer measures a distance between nodes by using a UWB pulse sequence having a spectrum ranging approximately from 100 MHz to 1 GHz, and performs communications between the nodes. This localizer does not employ a carrier signal, but generates a PN code by using a doublet which contains a positive pulse and a negative pulse generated with intervals of several picoseconds, as a transmission unit, “chip.” Combination of these PN codes represents data. Receiving timing of the PN codes is detected as a timing in which a correlator at the receiving end obtains maximum correlation value. Then, the distance is measured by using the receiving timing. The localizer 206 may contain a battery for driving a transceiver in it.

The attachment portion 202 may be a sucking disc for a glass plate or a plastic plate, or a magnet for iron materials. Alternatively, an adhesive tape may be used for the attachment portion 202. Or, the attachment portion 202, and an attachment portion 216 provided on an object 214 may be a hook side and a loop side of a hook-and-loop tape (“Velcro” tape) which is easy to attach and detach.

In one embodiment, the information sensing portion 204 includes a sensor and a microprocessor. The sensor provided in the information sensing portion 204 can be one or more sensors selected from, for example, a sound sensor, a temperature sensor, a position sensor, a light sensor, an infrared sensor, a magnetic sensor, and a pressure sensor. However, in another embodiment, the information sensing portion 204 may contain no sensor. The microprocessor provided in the information sensing portion 204 is used for processing various data. The information sensing portion 204 may obtain its power supply from a built-in battery, or a power supply adaptor for AC 100 V. The Knowledge data and the sensing model described later are stored in the information sensing portion 204. The display device 208 provided in the information sensing portion 204 displays information. The microprocessor stores and processes information input by the rotary switches 210 and 212.

The processor provided in the information sensing portion 204 controls the node 200, and the localizer 206 exchanges messages with neighboring nodes, and measures the distances to the neighboring nodes. The switches 210 and 212 are, for example, a rotary switch for inputting a code representing the attachment object 214, and a rotary switch for setting a mode, respectively. However, a type of the switches and the number of the switches are not limited to those shown here. The node 200 may include a GPS (global positioning system) for obtaining an absolute location, and providing the control node 104 or the M2M center 110 with the location information.

1.3 M2M System

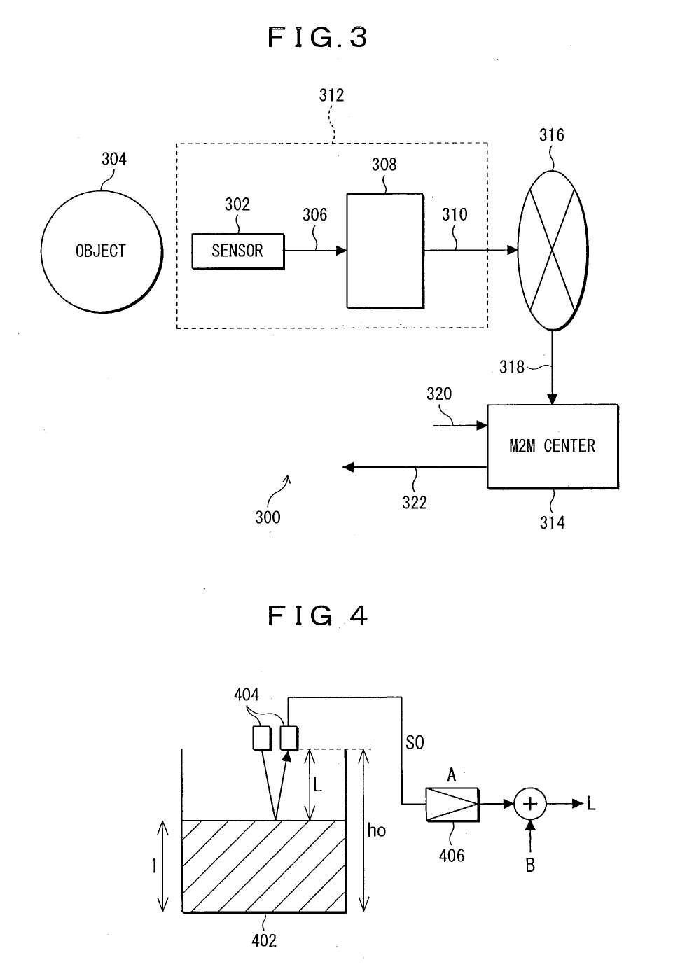

FIG. 3 is a diagram illustrating an M2M (machine-to-machine) system 300. In one embodiment, the AHS utilizes an M2M system. Thus, before describing the AHS in detail, the M2M system 300 will be described in detail below referring to FIG. 3.

In an example of the M2M system 300 shown in FIG. 3, first, a sensor 302 detects a parameter corresponding to a sensing object 304, and outputs sensing information represented by an output signal 306. A sensing model 308 receives the sensing signal 306 corresponding to the sensing information, and converts the signal into condition data 310. As such, a different element (e.g., a remote computer) may utilize the condition data 310 for a different purpose at a different place. As a result, exchange of the condition data 310 reflecting the sensing information 306, and supply and exchange of application services can be performed.

Here, the condition data 310 represents a condition of the sensing object 304, and does not include an attribute of the sensor 302. In this specification, an “M2M sensor” 312 is an element generating the condition data 310 which is not affected by the attribute of the sensor 302. The M2M sensor 312 is not affected by, for example, a position, an orientation, and an amplification rate of the sensor.

The M2M center 314 receives the condition data 310 via a communication network 316. The communication network 316 may include any information medium, such as the Internet, an intranet, a network using wireless communication, or a public telephone line. The condition data 310 may be modified to a suitable format depending on the protocol or the data format used for the communication network 316, and transferred as “modified” condition data 318.

The M2M center 314 receives the condition data 310, determines an output data U 322 depending on a value of a purpose data representing the purpose, and outputs the output data. The condition data 310 (labeled as “Condition”) is general-purpose data since it is “normalized.” The M2M center 314 is capable of storing knowledge data as a general purpose one, and utilizing it since it represents “what output to be generated in what condition for achieving what purpose.” This is represented by the following equations:

Condition=M2Msensor(Object,Sensing Model); (1)

U=M2MCenter(Purpose, Condition). (2)

FIG. 4 is a diagram illustrating a process for obtaining the above-described condition data “Condition.” Suppose that a liquid surface level 1 of a tank 402 is to be obtained as the condition data “Condition.” A sensor 404 is provided at a position ho from a bottom surface of the tank 402. An output signal “so” output by the sensor 404 is amplified by an amplifier 406 having an amplification rate A. Then, an output signal L is obtained by adding a signal output from the amplifier 406, and a signal B. This signal L corresponds to the distance between the sensor 404 and the liquid surface level. Therefore,

L=A·so+B, l=ho−L.

Hence,

l=ho−A·so−B=−A·so+(ho−B). (3)

In other words, in order to obtain the liquid surface level 1 from the output signal so from the sensor 404, normalization should be done using the equation (3). By using the function represented by the equation (3) as the sensing model 308, the liquid surface level 1 is obtained as the condition data 310.

As described above, the M2M sensor 312 performs conversion represented by the equation (1). That is, the M2M sensor 312 generates the condition data 310 “Condition” based on the sensing object 304 “Object,” and the data “sensing model” corresponding to the sensing model 308. The M2M center 314 performs conversion represented by the equation (2). That is, the M2M center 314 generates the output data 322 “U” based on the data “Purpose” corresponding to the purpose, and the condition data 310 “Condition.” The rule representing the relationships between the purpose data “Purpose” and the condition data 310 “Condition,” and the output data 322 “U” is stored in, for example, the database 114.

As described above, the system 100 according to one embodiment of the present invention generates the normalized data “Condition” based on the normalization model “Sensing Model” using the raw data obtained from a sensor. The system 100 selects a rule used for processing the generated normalized data “Condition” from a plurality of rules contained in the database, based on a type of the normalized data. The system 100 generates a processing result based on the data “Purpose” representing the purpose of the data processing, and the selected rule. As an example of the data “Purpose” representing the purpose, there is a query requiring an answer for a designated variable, or a command requiring substitution of a designated value for a designated variable.

Based on this processing result, the system 100 issues a warning to a watchman, or drives an actuator. Further, in an specific embodiment, the system 100 feedbacks the selected rule and/or the sensing model to the sensor via a communication network. The above-identified “Condition” represents only an attribute of the “Object,” and does not have an attribute of the sensor. Thus, exchanges of sensed data with high compatibility can be achieved between a plurality of machines.

These data represented by the equations (1) and (2) may be expressed in a suitable form, such as a scalar value, a vector value, or a matrix. Also, in an actual situation where data is exchanged between elements, any medium may be utilized. For example, these data may be represented by a digital signal or an analog signal, and transmitted using a medium, such as a conductive wire, an optical fiber, a radio wave, or light.

2. Detailed Operation of the System

Each step described in the above section 1 will be described in detail for a specific embodiment of the invention. According to one embodiment of the present invention, the system 100 performs the following steps 1-8 sequentially. As understood by those skilled in the art, the details to implement the following steps are not necessarily essential to the invention. Rather, omission, modification, and substitution of an equivalent may be done in a suitable manner.

2.1 STEP 1 (Installation of Nodes)

First, the operator 120 of nodes turns on the power supply of each node 200, and sets the operation mode to the node number generation mode by, for example, the switch 212. By doing this, a node number is randomly generated, and is automatically stored in a non-volatile memory provided in the node 200. In this manner, the node number assigned to the node 200 is displayed in a node number display area on the display device 208 shown in FIG. 2.

The operator 120 transmits the “system's purpose” to the M2M center 110 by using the install tool 118. This system's purpose may be, for example, surveillance of a house during night time, or surveillance of a warehouse for an unauthorized person's entry. The operator selects at least one purpose, and tells the M2M center 110 regarding what rule should be used to process data from the sensor 200 by using the switch 210 or 212. In one embodiment, this system purpose setting may be omitted by automatically assigning the default purpose to the node.

From the M2M center 110, instruction information designating a type and a location of the object 214 on which the node 200 is attached is sent to the install tool 118 via the communication network 112. This instruction information is generated based on the system's purpose and the type of the object in a suitable manner. The communication network 112 is a suitable network of hardwired or wireless, or combination thereof. For example, an intranet, the Internet, a public telephone line, a wireless network, a network using light, or any combination thereof may be used.

According to the instruction information sent to the install tool 118, the operator 120 selects a type of the object 214 to which the node 200 is attached by, for example, rotating the switch 210 which is a rotary switch. For example, the operator 120 may select one name of a plurality of object types which are displayed on the display device 208. When a rotary switch is used as the switch 210, a type of the object 214 can be input by stopping the rotation of the switch when the display device 208 displays the type name of the attached object 214.

2.2 STEP 2 (First-Phase Self-Organization: Generating Attribute at Each Node)

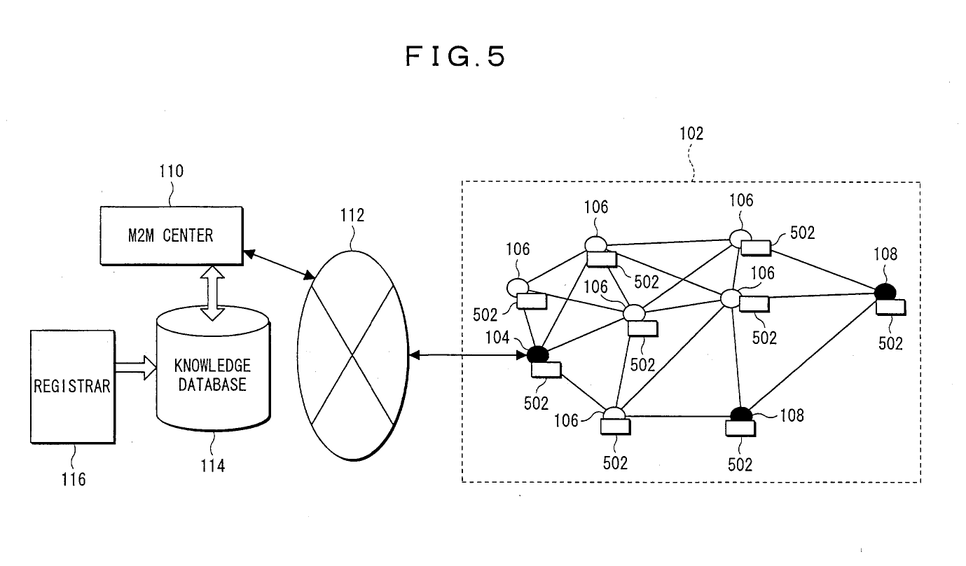

FIG. 5 is a diagram illustrating a process for generating an attribute for each node. After generating its node number, each node 106 and 108 of the Hagoromo 102 will remain the standby mode until receiving a start command for first phase self-organization from the control node 104. The mode of the control node 104 is set to “first-phase self-organization” by the switch 212 shown in FIG. 2.

STEP 2a

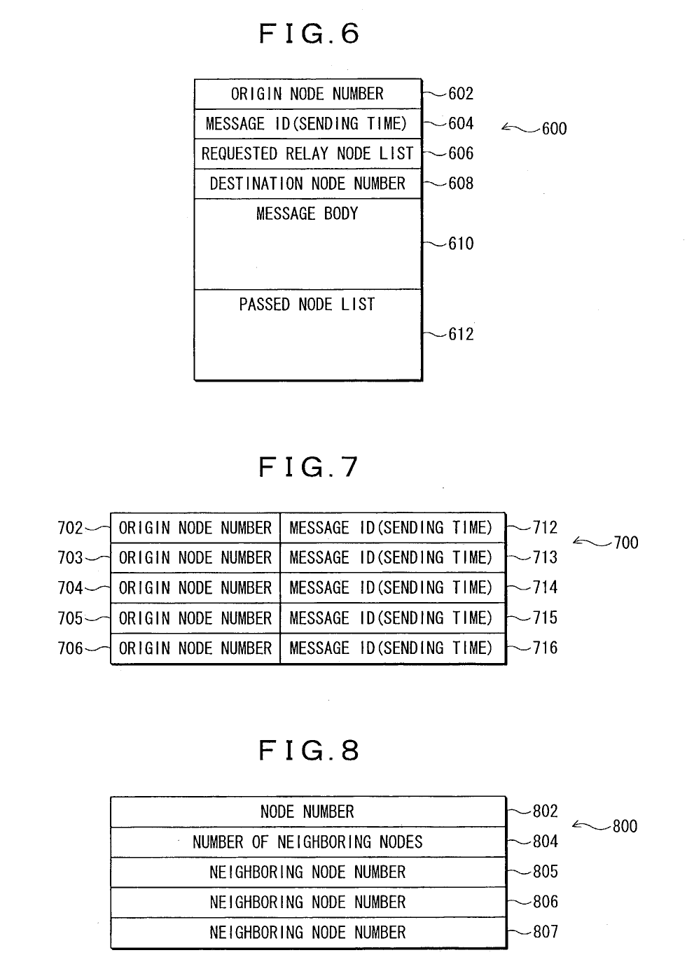

Then, the control node 104 sends a message corresponding to “first-phase self-organization” to the nodes 106 and 108 on the self-organization wireless communication network 102. FIG. 6 is a diagram illustrating a data format of this message 600. The message 600 includes data representing an origin node number 602, a message ID 604, a requested relay node list 606, a destination node number 608, a message body 610, and a passed node list 612. The message 600 is exchanged using a suitable format and protocol for transmission over the communication network 112, and may include data other than the above described data, such as a header, a trailer, a flag, additional data, or a time stamp. Here, the origin node number 602 includes data representing a node number of the control node 104. The message body 610 includes data corresponding to “first-phase self-organization.” That is, the message body is substituted with a suitable code or symbol which represents the “first-phase self-organization.” The message ID 604 includes data representing a time at which the control node 104 sends the data in order to uniquely identify the message.

STEP 2b

FIG. 7 is a diagram illustrating a received message list 700 provided in each node 106 and 108. This received message list 700 is stored in a data storing device (for example, a non-volatile semiconductor memory) provided in a node. In the received message list 700, a node number of a node which transmits a message is associated with a message ID of the message. In other words, origin node numbers 702-706 correspond to message ID 712-715, respectively. The received message list 700 stores a suitable number of pairs of the origin node numbers and the message ID in a manner of first-in, first-out (FIFO). When each node 106 and 108 receives a message representing the “first-phase self-organization” from the control node 104, the origin node number 602 and the message ID 604 forming a pair are stored in the received message list 700.

Then, the nodes 106 and 108 each add its own node number to the passed node list 612 in the received message 600, and transfers it to other nodes. Thus, the passed node list 612 expresses a path followed by the message 600 as nodes which have been passed by the message. In one embodiment, exchanges of a message among nodes can be performed by wireless communication using electromagnetic wave as a medium. Thus, in reality, a message from a certain node can be received by only nodes within the range in which the radio wave can reach. By selecting a distribution of nodes appropriately (for example, by positioning nodes sufficiently densely), the message from the control node 104 can be transmitted to all nodes on the Hagoromo 102 by passing through a plurality of nodes. Specifically, a node attempting to transmit a message determines whether a communication channel is occupied by another message which is transferred from another node before the transmission. If the channel is not occupied, the node transfers the message on the channel. If it is occupied, the node will wait until the transmission by another node is finished. This will avoid collision of the message traffic. This message transmission method may be used in communications in the embodiments described below.

STEP 2c

Each node relays a message to other nodes if the message is received for the first time. If its own node number is not described in the passed node list 612, or if a pair of the origin node number 602 and the message ID 604 is not included in its own received message list 700, the node determines that the node is receiving the message for the first time. If the node receives the message for the first time, the node adds the origin node number 602 and the message ID 604 to the received message list 700, adds its own node number to the passed node list 612 of the message, and then, forwards the message to its neighboring nodes. If its own node number is included in the passed node list 612, or if a pair of the origin node number 602 and the message ID 604 is included in its received message list 700, the node will not forward the message to other nodes since the message has been already received before. This will avoid a situation in which a message is kept being forwarded infinitely between neighboring nodes forming a loop.

STEP 2d

FIG. 8 is a diagram illustrating a neighboring node list 800 provided in each node 106 and 108. Its own node number 802 indicates a number assigned to the node.

A number of neighboring nodes 804 indicates a total number of neighboring nodes 805-807. In this specification, a neighboring node means a node which has successfully communicated with the node in question. In most cases, nodes located close to the node in question correspond to the neighboring nodes, but with some exceptions. A node corresponding to the last node number in the passed node list of a received message directly communicated with the node in question, and thus, is deemed to be a neighboring node. Each node stores a node number listed at the last of the passed node list 612 of a received message into the neighboring node numbers 805-807 of the neighboring node list 800 sequentially. In the example of FIG. 8, only three neighboring node numbers 805-807 are stored. However, the number of stored node numbers may be varied based on the distribution of nodes located on the Hagoromo 102. For example, when nodes are densely positioned (i.e., many nodes exist in the neighborhood of a certain node), more neighboring node numbers (e.g., 10-100 node numbers) may be stored. If the node number is included in the neighboring node list 800, the node will not add the node number to the neighboring node list 800. This avoids storing the same node number in duplicate into the neighboring node list 800.

STEP 2e

If a time period in which no message arrives exceeds a certain length, all nodes are deemed to have completed their neighboring node list 800. That is, a message sent from the control node 104 is forwarded from one node to another. However, if a message which has been received at the node is received again, that message will not be forwarded again. As a result, forwarding of a message within the network 102 is finished within a finite time. In FIG. 5, the nodes 104, 106 and 108 retain the node attribute information 502 corresponding to it as described later.

STEP 2f

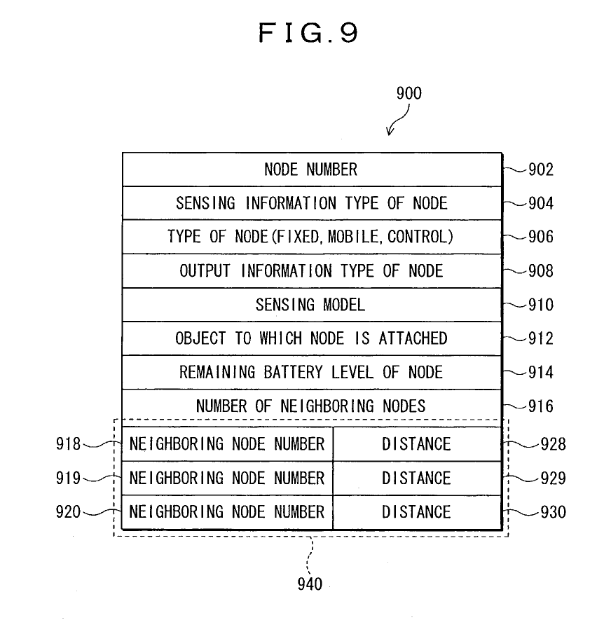

FIG. 9 is a diagram illustrating a format of data 900 representing attribute information of each node. Each node stores and retains the node attribute information 900 in its own memory. The node attribute information 900 includes a node number 902, a sensing information type 904 of the node, a node type 906, an output information type 908 of the node, a sensing model 910, an object 912 to which the node is attached, a remaining battery level 914 of the node, a number 916 of neighboring nodes, neighboring node numbers 918-920, and distances 928-930 to the neighboring nodes.

The node type 906 indicates one of, for example, a fixed node, a mobile node, and a control node.

In one embodiment, the output information type 908 of the node is, for example, “data indicating abnormality.” Such data indicating abnormality is generated based on an output from a sensor of the node (e.g., data indicating vibration), and an output from a neighboring node (e.g., data indicating light). Thus, the output information type of the node represented by the type 908 may be different from that of a direct output from the information sensing portion 204 of the node 200.

The number 916 of the neighboring nodes shown in FIG. 9 includes the number 804 of the neighboring nodes shown in FIG. 8. The neighboring nodes 918-920 shown in FIG. 9 include the neighboring nodes 805-807 shown in FIG. 8.

The node number 902 and the remaining battery level 914 of the node are automatically generated by the self-organization network 102. The sensing information type 904 of the node, the node type 906, and the output information type 908 of the node are initially set at the time when the node 200 is manufactured. The object 912 to which the node is attached is manually input by the operator 120 at an install site.

Each node measures distances from the node to all of its neighboring nodes based on the neighboring node list 800. In one embodiment, this distance measurement is done by using the above-mentioned localizer 206. However, the distance measuring method is not limited to this, and thus, other suitable methods may be used for measuring distances between nodes. With respect to a neighboring node of which a distance has been successfully measured, its neighboring node number and the corresponding node distance are sequentially written into the neighboring node numbers 918-920 and the distances 928-930 in the node attribute information 900. Thus, the neighboring node numbers 918-920 correspond to the distances 928-930, respectively. That is, the distance 928 represents a distance between a node of which distance is currently measured, and a neighboring node represented by the node number 918. These pairs of the neighboring node numbers 918-920 and the corresponding distances 928-930 are hereinafter referred to as a neighboring node distance list 940. The neighboring node distance list 940 is utilized to generate the “fingerprint” of the system 102 as described later in detail.

2.3 STEP 3: (Second-Phase Self-Organization: Generating the System Structure Information by the Control Node)

STEP 3a

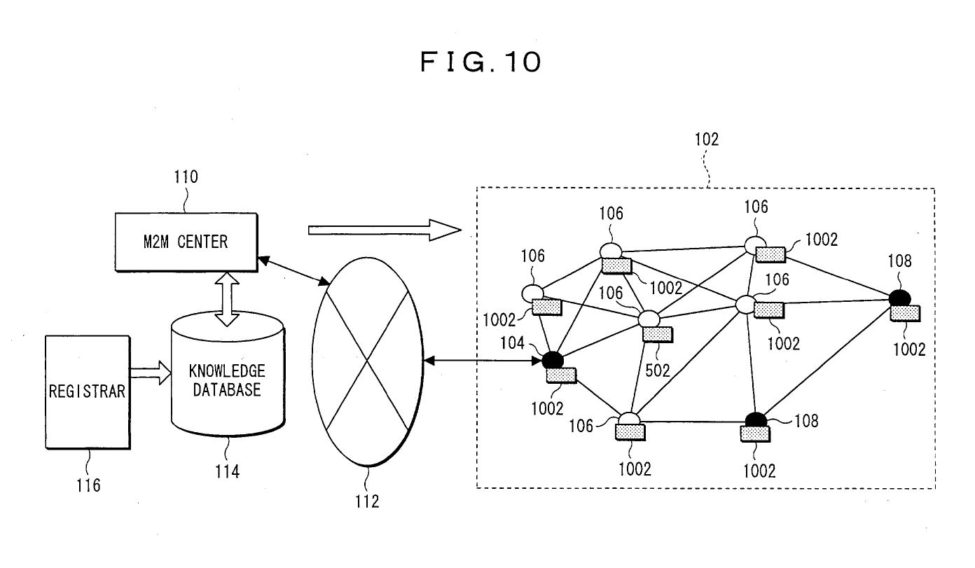

FIG. 10 is a diagram illustrating a process of downloading knowledge data to each node. The control node 104 sends a message designating all nodes as destinations, i.e., a “neighboring node distance list report command,” which “requires transmission of the neighboring node distance list 940 to the control node 104 as a destination.”

STEP 3b

The nodes 106 and 108 which have received the neighboring node distance list report command from the control node 104, according to the command, generate a neighboring node distance list report message in order to send its own neighboring node distance list to the control node 104. This message includes the neighboring node distance list 640 shown in FIG. 9 in the message body 610 shown in FIG. 6, and designates the control node 104 as a destination node. Each node forwards a message generated in this manner to all of its neighboring nodes.

STEP 3c

If each node receives a message for the first time, in a manner similar to STEP 2c, that node forwards the message to other nodes. That is, if its own node number is not described in the passed node list 612, or if a pair of the origin node number 602 and the message ID 604 is not included in its own received message list 700, the node determines that the node is receiving the message for the first time. If the node receives the message for the first time, the node adds the origin node number 602 and the message ID 604 to the received message list 700, adds its own node number to the passed node list 612 of the message, and then, forwards the message to its neighboring nodes. If its own node number is included in the passed node list 612, or if a pair of the origin node number 602 and the message ID 604 is included in its received message list 700, the node will not forward the message to other nodes since the message has been already received before.

STEP 3d

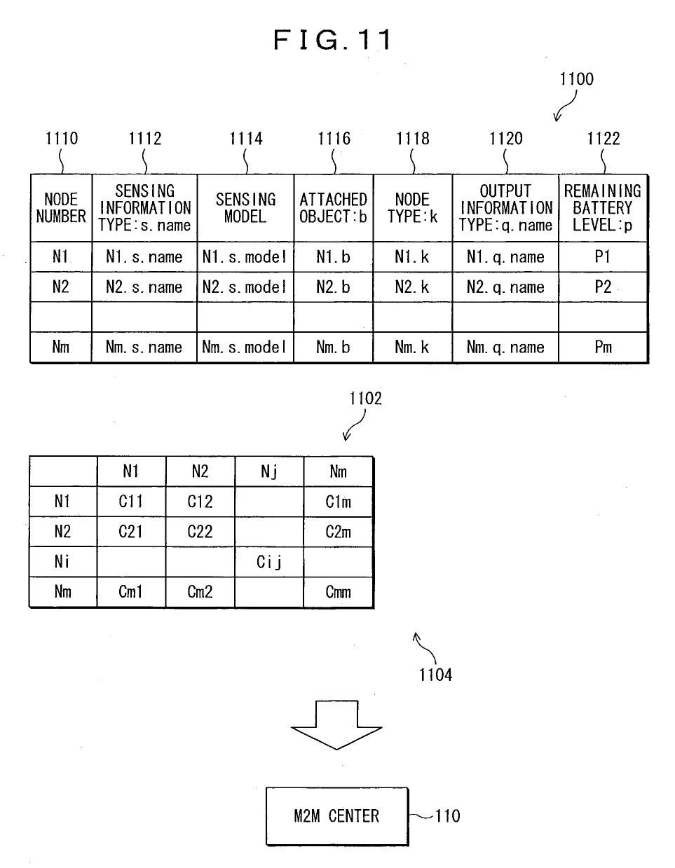

If the control node 104 receives a message of which destination node number 608 includes its own node number, the control node 104 stores the origin node number 602 and the message ID 604 of the message into the received message list 700 of the node. If this message is the above-described neighboring node distance list report message, the control node stores the message into a work area of its memory (i.e., a temporary store area). Based on all of received neighboring node distance list report messages, the control node 104 generates data about all the nodes, and the “fingerprint data.” FIG. 11 is a diagram illustrating a node data 1100, and a fingerprint data 1102 generated in this manner. A system structure information 1104 according to one embodiment of the present invention includes at least one of the node data 1100, and the fingerprint data 1102. Also, in a specific embodiment, the system structure information 1104 includes both of the node data 1100, and the fingerprint data 1102.

In one embodiment, the node data 1100 includes a sensing information type 1112, a sensing model 1114, an object 1116 to which the node is attached, a node type 1118, an output information type 1120, and a remaining battery level 1122 for each node. However, the node data 1100 is not limited to this, and thus, it may omit a part of the data, or may include additional data.

In a specific embodiment, the fingerprint data 1102 is represented by a matrix including distances Cij between nodes. The distance Cij represents a distance between a node Ni and a node Nj (i, j: integer). However, if the distance cannot be measured, or communication cannot be established, a “−1” is substituted for the Cij. Also, if i=j, a “0” is substituted for the Cij (=Cii).

STEP 3e

In order to store the fingerprint data 1102 in each node of the Hagoromo, the control node 104 transmits a message which includes the fingerprint data 1102 in the message body 610, to its neighboring nodes. Each node utilizes this fingerprint data 1102 to determine a forwarding node for message relaying, or to detect abnormality of the neighboring nodes. In other words, the fingerprint data 1102 is stored in the message body 610 of the message structure 600 shown in FIG. 6; the steps 2b-2e are performed; and the message is sent from the control node 104 to all nodes 106 and 108. The method for message transfer using the fingerprint data 1102 will be described below.

Method for Message Transfer using the Fingerprint Data

When each of the nodes 106 and 108 receives the fingerprint data 1102, each of them stores the fingerprint data 1102 in a memory, and later uses the fingerprint data 1102 for message transfer to other nodes. That is, each of the nodes analyzes the fingerprint data 1102, and generates a predetermined number of paths connecting a destination node described in the received message and its own node, in the ascending order of the total distance in the path. Then, each of the nodes extracts a next node in each of the generated paths, stores a predetermined number of the next node's numbers in the requested relay node list 606 of the message, and then, transmits the message. Other nodes refer to the requested relay node list 606 and the destination node number 608 in the received message, and will not perform forwarding the message if none of the list 606 and the number 608 contains its own node number. If the destination node number 608 is its own node number, then the node receives the message, and writes the origin node number 602 and the message ID 604 of the message into the received message list 700. If its own node number exists in the requested relay node list 606, then the node receives the message, and writes it into the received message list 700. Then, the node searches a path from itself to the destination node 608 as described earlier, updates the requested relay node list 606, and transmits the message.

In a specific embodiment, each node generates a plurality of message transmission paths using the fingerprint data depending on the importance of the message, and forwards the message. For example, if the importance of the message is high, more reliable communications between nodes will be assured by sending with high redundancy through increased number of the transmission paths depending on the importance.

STEP 3f

The control node 104 sends the system structure information 1104 (the node information 1100 and the fingerprint data 1102 in this embodiment) to the M2M center 110 via the communication network 112.

2.4 STEP 4: Extracting Knowledge Data to be Retained by Each Node

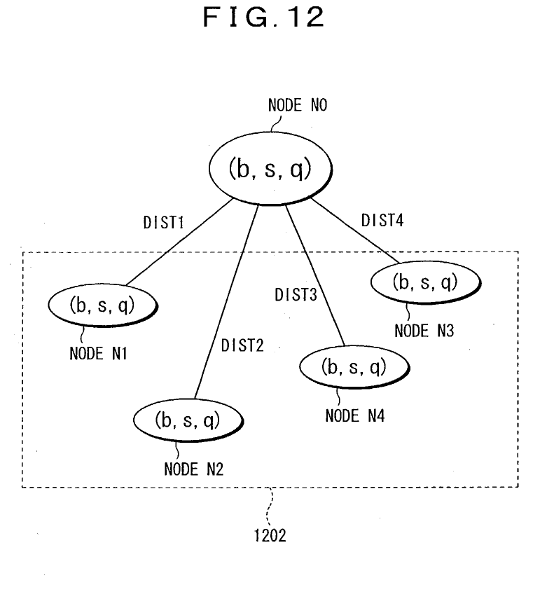

When the M2M center 110 receives the system structure information 1104, the center registers the fingerprint data 1102 in the information 1104 as an ID pattern of the system 102 represented by the control node 104. FIG. 12 is a diagram illustrating a relationship between a certain node N0 and nodes N1-N4 locating its neighborhood. The M2M center 110 stores the neighboring node distance list 940 sent from the node N0. The list 940 determines a neighboring node group 1202 including nodes N1-N4 locating in the neighborhood of the node N0. The node N0 indicates a node in question for which data is currently processed. As described below, by performing data processing of the node N0 for each of all nodes on the network 102, rules for all nodes are extracted.

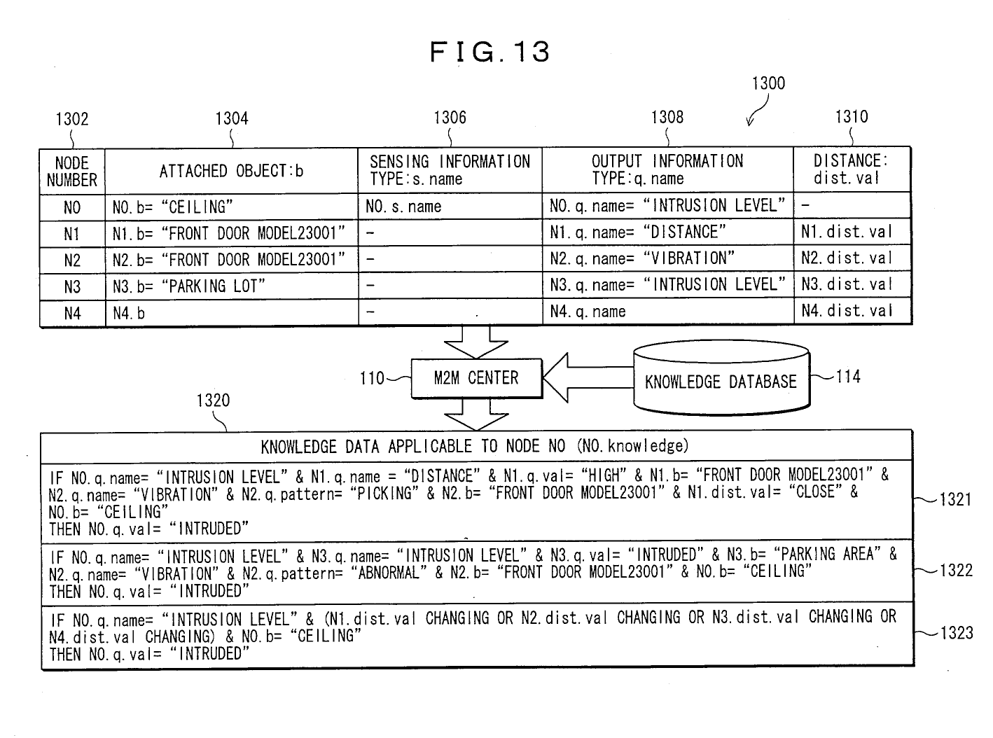

FIG. 13 is a diagram illustrating neighboring node attribute data 1300 for the nodes N0-N4 obtained by the M2M center 110 using the system structure information 1104. The attribute data 1300 includes a node number 1302 for each node N0-N4, an object 1304 to which the node is attached, a sensing information type 1306, an output information type 1308, and a distance 1310 with the node N0. As shown in FIGS. 12 and 13, the nodes N0-N4 are associated with the corresponding attached object 1304 (“b”), the sensing information type 1306 (“s.name”), the output information type 1308 (“q.name”), and the distance 1310 (“dist.val”). The labels in the double quotation symbols indicate suffixes which are added to the corresponding node names for each variable.

The method for selecting data necessary for the node N0 among the knowledge data stored in the knowledge database 114 will be described below. First, based on the fingerprint data 1102, the nodes N0-N4 located in the neighborhood of the node N0 are determined. Next, attribute data for the node N0, and the neighboring nodes N1-N4 will be extracted from the node information 1100. This extracted data is the neighboring node attribute data 1300. In addition, the M2M center 110 extracts knowledge data to be downloaded to the node N0 by searching the knowledge database 114, utilizing the neighboring node attribute data 1300. This series of operations will be performed with respect to all of the nodes 106 and 108 while switching the node N0 to a different node one by one. In this way, the knowledge data to be downloaded from the M2M center 110 are obtained with respect to all nodes 106 and 108 constituting the system 102.

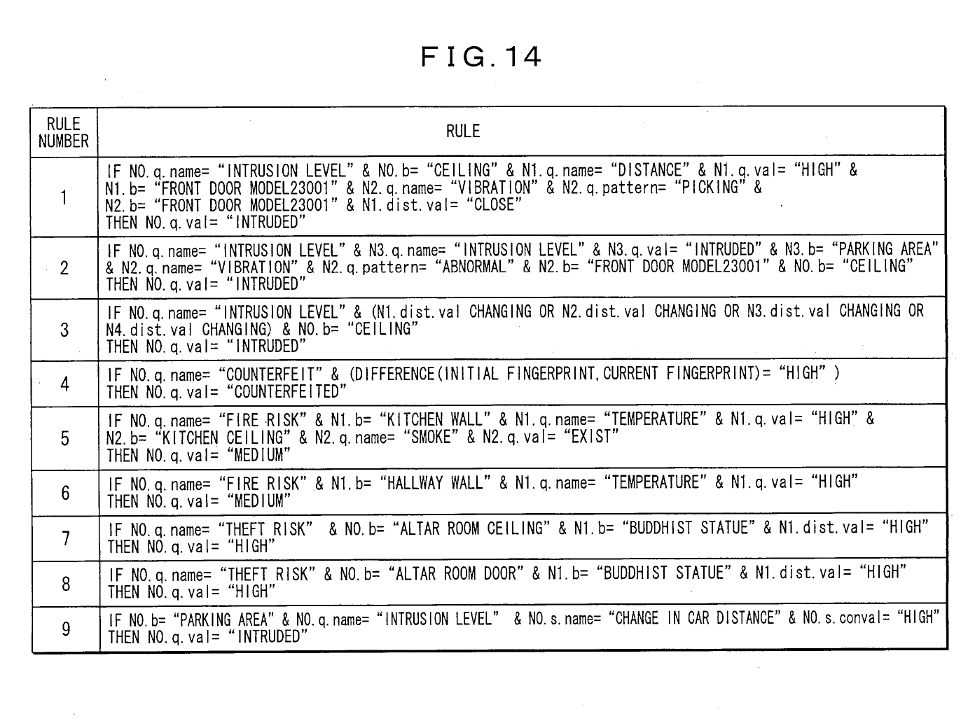

FIG. 14 is a diagram illustrating rules 1400 stored in the knowledge database 114. The rules 1400 include rules 1-9. Here, for an example, nine rules are shown. The node numbers N0-N4 in the rules indicate relative node numbers, not absolute node numbers. In other words, these numbers do not indicate the node numbers which have been actually allocated to each node by random numbers.

First, knowledge data in the knowledge database 114 is searched with respect to the output information type 1308 of the node N0 in the neighboring node attribute data 1300. That is, a rule which includes the same output information type as the output information type N0.q.name of the node N0 in its condition part is selected from the knowledge database 114. In this specification, the “condition part,” and the “conclusion part” correspond to the parts A and B, respectively, where there is a rule “If [A], then [B].” For example, in FIG. 13, since n0.q.name=“Intrusion Level” is defined, rules which have n0.q.name=“Intrusion Level” in its condition part will be selected among rules shown in FIG. 14. In this example, the rules 1-3 are selected as candidates. Since the rules 4-9 do not include n0.q.name=“Intrusion Level,” the download described later will not be performed.

Among the selected rules 1-3, a rule which includes the same output information type as the output information types N0.q.name-N4.q.name of the nodes N0-N4 in its condition part is selected. As a result, rules 1321-1323 shown in FIG. 13, which are applicable to the node N0, are selected from the rules in the knowledge database 114. These rules are generally referred to as knowledge data 1320 (“N0.knowledge”) which are applicable to the node N0.

For example, among many nodes actually installed, suppose that a node 8 is attached to a ceiling of an altar room, a node 9 is attached to a Buddhist statue, and the output information type of the node 8 is a risk against theft. In this case, also suppose that a distance between the nodes 8 and 9 is measured. Then, the rule 7 in the knowledge database 114 shown in FIG. 14 will be extracted. Also, the node N0 in the rule (i.e., “relative node number”) will be associated with an actual node 8 (i.e., “absolute node number”), and the node N1 in the rule will be associated with an actual node 9. In this way, the node number 1302 represents a number which is actually allocated to a node while a node number in the rules 1400 is relative. Therefore, in the process for selecting necessary rules based on the above-described output information type 1308, whether a certain output information type exists in the condition part will be determined by exhaustively substituting the absolute node number 1302 for a relative node number in the rules 1400. If all the rules applicable to a certain node N0 are determined, the relative node numbers in the rules 1400 will be associated with its node N0 and the corresponding neighboring nodes N1-N4 having absolute node numbers. By generating and retaining a neighboring nodes access table storing this relationships as a table, the access table can be used for accessing the neighboring nodes by the node N0.

2.5 STEP 5: Download of Knowledge Data

The M2M center 110 downloads the rules obtained by the above-described method to each node via the communication network 112. Information 1002 downloaded to each node represents rules which are necessary for operation of the system 100. Thus, in a specific embodiment, for example, rules related to a distant node from the node in question will not be downloaded. This selective download to the nodes according to one embodiment may have the advantages of reducing the memory capacity necessary for each node, and reducing communication time for downloading.

2.6 STEP 6: Tuning of Sensing Model

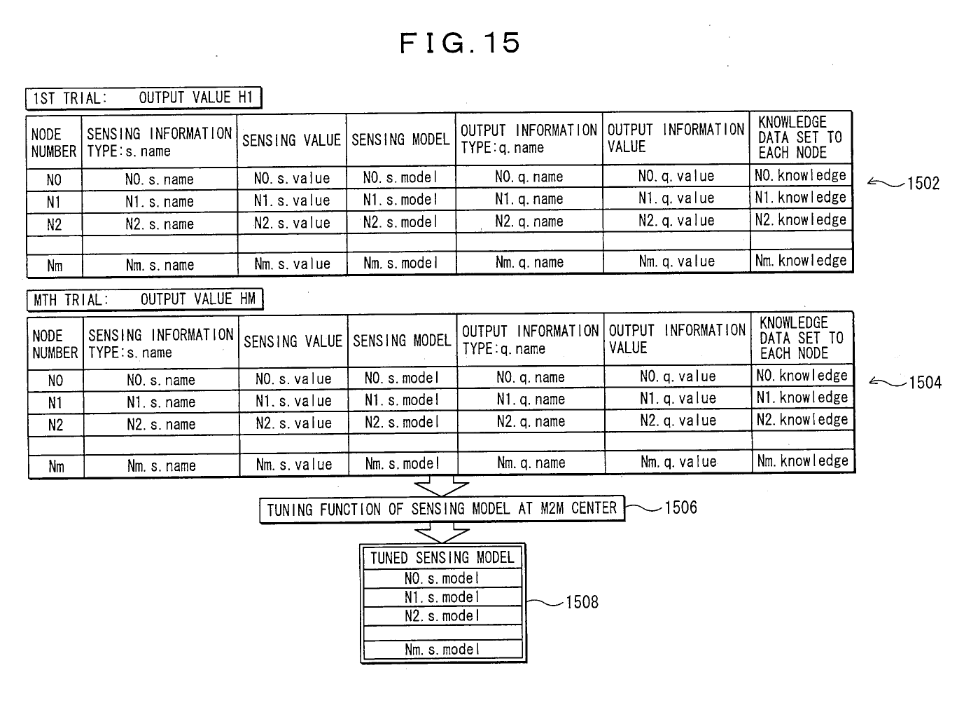

FIG. 15 is a diagram illustrating tuning at the M2M center, and downloading of the sensing model. The Hagoromo 102 performs tuning operation using knowledge data downloaded to each node. That is, the operator 102 performs a specific act on the sensing object or the sensing area as instructed by the M2M center 110 via the install tool 118. For example, if the sensing object is a front door of a house, the operator opens and closes the door, or inserts a metal rod in the key hole as if he were trying to pick the lock. At this time, signals detected by each node's sensor in the Hagoromo 102, and data output from each node are transmitted to the M2M center 110.

The M2M center 110 has a desired output data H corresponding to an act which the M2M center instructed the operator 120 to do. The M2M center 110 optimizes the sensing model for converting the signal detected by each node's sensor into a condition variable so that the data output from the Hagoromo 102 (i.e., the output data of the control node) is the same as the desired output H. For example, the M2M center 110 instructs the operator 120 to open the door via the tool 118. Suppose that the intrusion level should output “1” (“intruded”) when the door is opened. In the first trial, the desired output value H1 given by the M2M center, output information value from the control node, and a sensor output of each node are recorded as a first trial data. Similarly, in the next trial, the center instructs the operator to pick the lock. Then, the operator 120 gives abnormal vibration to the lock. If the intrusion level should be “1,” then a desired output value H2 for that intrusion level will be given by the M2M center 110. By this second trial, the desired output value H2 given by the M2M center, output information value from the control node, and a sensor output of each node are recorded as a second trial data. Similarly, in the next trial, the center instructs the operator to knock the door lightly. Then, the operator 120 knocks the door lightly. Since the intrusion level should be “0” for just a knocking on the door, a desired output value H3 for this intrusion level will be given by the M2M center 110. In this third trial, the desired output value H3 given by the M2M center, output information value from the control node, and a sensor output of each node are recorded as a third trial data.

In this manner, the desired output values in various cases, sensor output values in the cases, and output information values from the control node are stored as a set of data in the control node, and when this iteration reaches M times, the node will upload the whole data for M time iterations. The M2M center 110 performs tuning of the sensing model values so that output information value N0.q.value of the node N0 with respect to each iteration becomes the desired output value H.

In one embodiment, the sensing model is tuned by adjusting the sensing model so that a value of an evaluation function with respect to an error is minimized.

In a situation where a node N includes a sensor in it, the following sensing model will apply if a linear model is used:

N.s.conval=a0+a0*N.s.val,

where N.s.val is an output signal of the built-in sensor, N.s.conval is a value of a condition variable obtained by converting an output signal of the sensor, and a0 and a1 represent a sensing model. When the sensor Output is a pattern signal N.s.pattern, the sensing model is expressed as follows:

N.s.conpattern=Function(N.s.pattern, A_{—}vector).

2.7 STEP 7: Download of Sensing Model

The sensing model N0.s.model-Nm.s.model which are tuned as optimized values by the M2M center 110 in the step 1508 of FIG. 15 are downloaded to each node 104, 106 and 108 on the Hagoromo 102.

2.8 STEP 8: Starting Actual Operation

The Hagoromo 102 performs sensing operation by measuring distances between the nodes, communicating between the nodes, and applying the knowledge data at nodes; utilizing the sensing model 1508 which has been set to a optimized value, the knowledge data 1320 for each node, and the fingerprint data 1102. Then, the network 102 generates output data from the control node 104 in the sensing operation, and reports to the M2M center 110 via the communication network 112. The operation after the knowledge data is downloaded to each node will be described below.

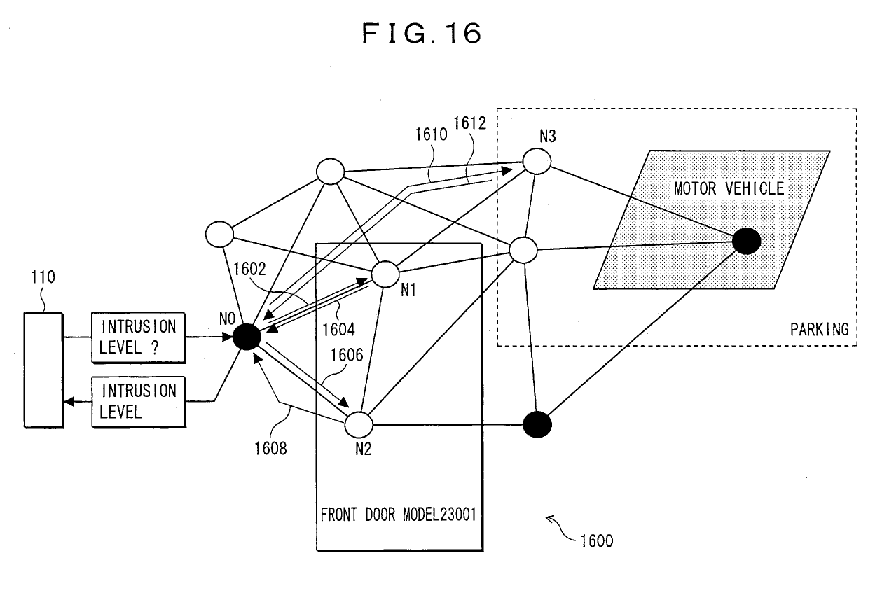

FIG. 16 is a diagram illustrating the system's operation according to an embodiment of the present invention. Suppose that the output information type of the control node 104 is set to “Intrusion Level,” and for example, a system 1600 shown in FIG. 16 supplies knowledge data to nodes N0 (a control node), nodes N1, N2 and N3 as shown in Table 1 below:

TABLE 1

| Node | | |
|---|---|---|
| Number | No. | Contents of Rules |
| N 0 | 1 | IF N0.q.name=“Intrusion Level” & N1.q.name=“distance” & |
| | | N1.q.val=high & N1.b=“front door Model23001” & N2.q.name=“vibration” |
| | | & N2.q.pattern=“picking” & N2.b=“front door Model23001” & |
| | | N1.dist.val=“close” |
| | | THEN N0.q.val=“Intruded” |
| N 0 | 2 | IF N0.q.name=“ Intrusion Level” & N3.q.name=“ Intrusion Level” & |
| | | N3.q.val=“Intruded” & N3.b=“Parking Area” & N2.q.name=“vibration” & |
| | | N2.q.pattern=“abnormal” & N2.b=“front door Model23001” |
| | | THEN N0.q.val=“Intruded” |
| N 1 | | N/A |
| N 2 | | N/A |
| N 3 | 3 | IF N3.b=“Parking Area” & N3.q.name=“ Intrusion Level” & |
| | | N3.s.name=“change in car distance” & N3.s.conval=“high” & |
| | | N0.b=“ceiling” |
| | | THEN N3.q.val=“Intruded” |

A query “What is the intrusion level?” from the M2M center 110 reaches the control node N0. Then, the rules 1 and 2 stored in the node N0 are activated. In FIG. 16, the communication network 112 between the M2M center 110 and the control node N0 is omitted. From the conditional part of the rule 1, a query from the node N0 to the node N1 about the “distance of the front door” represented by N1.q.name=“distance” is sent (1602). In response to this query, the node N1 sends back an answer represent by N1.q.val as the “distance of the front door” (1604). From the conditional part of the rule 1, a query to the node N2 about the “vibration waveform” represented by N2.q.name=“vibration” is given (1606). Then, a waveform represented by N2.q.pattern is returned from the node N2 (1608). Further, a distance N1.dist.val between the node N0 and the node N1 should be obtained. In this case, the node N0 measures the distance between itself and the node N1. The node N0 determines a degree of “N1.q.val=high,” a degree of “N2.q.pattern=‘Picking’,” and a degree of “N1.dist.val=‘close’.” By synthesizing these determination results, the node N0 calculates the degree of “N0.q.val=‘intruded’” in the conclusion part. A technique for dealing with pattern information and scalar information consistently in a rule is described in Japanese Laid-Open Patent Publication No. H06-35706.

From the conditional part of the rule 2, a query from the node N0 to the node N3 about the “intrusion level” represented by N3.q.name=“intrusion level” is sent (1610). In response to this query, the node N3 attempts to measure N3.s.name=“change in car distance” by activating the rule 3. After it is measured, the node N3 will evaluate a degree of “N3.s.conval=‘high’.” Depending on the degree to which “N3.s.conval=‘high’” applies, obtained in this manner, the node N3 presents the degree to which the intrusion level corresponds to “intruded.”

In this way, the value N3.q.val, i.e., a degree represented by “N3.q.name=‘intrusion level’” used in the condition part of the rule 2 is obtained (1612). Then, a degree to which a value of N3.q.val corresponds to “intruded” is calculated. Further, a query of “vibration waveform” represented by N2.q.name=“vibration” is given to the node N2. Then, a waveform represented by N2.q.pattern is returned from the node N2. Thus, a degree to which “N2.q.patten=‘abnormal’” applies is calculated. By using each degree in the condition parts thus obtained, a degree to which “N0.q.val=‘intruded’” in the conclusion part is calculated.

By synthesizing the degree to which “N0.q.val=‘intruded’” in the conclusion part of the rule 1, and the degree to which “N0.q.val=‘intruded’” in the conclusion part of the rule 2, a conclusion for the entire system will be obtained. The node N0 will send the conclusion to the M2M center 110 as an answer for the query from the M2M center 110 to the control node N0, i.e., “What is the intrusion level?” A technique for generating an answer to a query from outside by parsing a query from outside, and synthesizing answers to lower-level queries generated by the parsing is described in detail in Japanese Patent No. 2605828. Japanese Patent No. 3312141 describes a method for processing “a command to require an answer for a value of the variable by setting a designated variable to a designated value.” Japanese Patent No. 3312141 also describes a detailed technique for generating answers to queries from outside.

In an embodiment, the system 100 retains the fingerprint data in the “initial condition,” i.e., a condition where the sensor installation has been just finished. Then, the system compares the current fingerprint data with the initial data, and may give a warning for abnormality of the sensor when the difference is too large so that the sensor's position has been changed. In this case, the rule 4 shown in FIG. 14 will be applicable. In order to compare a plurality of fingerprint data, for example, a summation of absolute values of the differences of the corresponding matrix elements can be used. If the summation exceeds a predetermined threshold value, it is determined that the two sets of the fingerprint data are different. For comparison of a plurality of fingerprint data, other suitable methods can be used. By this technique, the system 100 can detect abnormality even only a single sensor has been moved among many sensors that the system 100 provides.

The node numbers stored in the memory of each node are obtained, for example, by a random number generator. Thus, if the system 100 checks each node's node number with the corresponding node number in the initial condition, the system can detect a fake sensor which was substituted for an authorized sensor. More generally, comparison of the initial system structure information 1104 with the current system structure information 1104 for each node can detect abnormality of the network 102.

In the specification, a plurality of elements which are shown as separate elements can be integrated for actual implementation in other embodiments. For example, the M2M center 110 may include the knowledge database 114.

Various data described in the above embodiments can be partly omitted, or can be modified with additional data. A data format is not limited to a table form. Each format may be any suitable form as long as the data is associated with each other so that it is easy to retrieve the data.

The system 100 according to one embodiment of the present invention has three major functions: (1) function for downloading knowledge data to a node, (2) function for tuning a sensing model, and (3) function for detecting abnormality of the network by checking the fingerprint data. These functions can be used alone or in combination. Also, in order to implement these functions, a computer system described below may be utilized. A method according to the embodiment of the present invention can be described as a code executable on a computer system, and can be recorded on a recording medium.

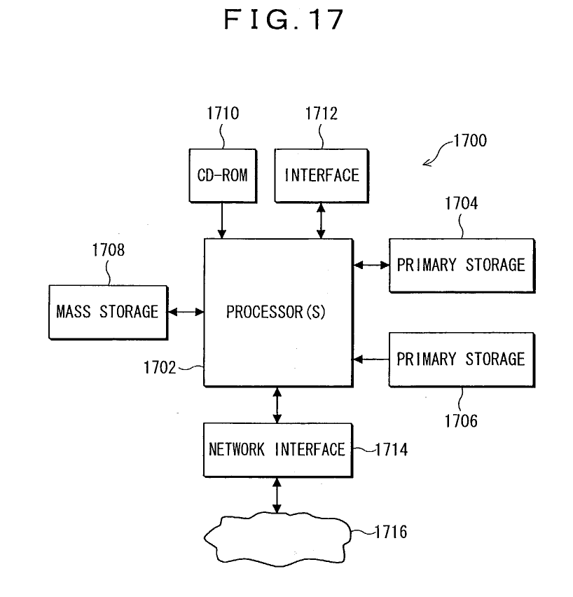

FIG. 17 illustrates a typical computer system used for implementing some embodiments of the present invention. The computer system 1700 includes any number of processors 1702 (also referred to as controllers, CPUs, or central processing units) that are coupled to storage devices including primary storage 1704 (typically a RAM), primary storage 1706 (typically a ROM). As is well known in the art, the primary storage 1704 acts to transfer data and instructions bi-directionally to the CPU and primary storage 1706 is used typically to transfer data and instructions in a uni-directional manner. Both of these primary storage devices may include any suitable type of the computer-readable media described above. A mass storage device 1708 is also coupled bi-directionally to CPU 1702, and provides additional data storage capacity and may include any of the computer-readable media described above. The mass storage device 1708 may be used to store programs, data and the like and is typically a secondary storage medium such as a hard disk that is slower than primary storage. It will be appreciated that the information retained within the mass storage device 1708, may, in appropriate cases, be incorporated in standard fashion as part of primary storage 1704 as virtual memory. A specific mass storage device such as a CD-ROM 1710 may also pass data uni-directionally to the CPU 1702.

CPU 1702 is also coupled to an interface 1712 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1702 optionally may be coupled to a computer or telecommunications network 1716 including the Internet and/or an intranet (typically a LAN, or local area network) using a network interface as shown generally at 1714. With such a network interface, it is contemplated that the CPU 1702 might receive information from the network 1716, or might output information to the network in the course of performing the above-described method operations. The above-described devices and materials will be familiar to those of skill in the computer hardware and software arts.

The network interface 1714 is typically provided as an interface card (sometimes referred to as a “line card”). Generally, it controls the sending and receiving of data packets over the network and sometimes support other peripherals used with the computer system 1700. The network interface 1714 may be one of Ethernet interfaces, frame relay interfaces, cable interfaces, DSL (Digital Subscriber Line) interfaces, token ring interfaces, and the like. In addition, various very high-speed interfaces may be provided such as fast Ethernet interfaces, Gigabit Ethernet interfaces, ATM (Asynchronous Transfer Mode) interfaces, HSSIs (High-Speed Serial Interfaces), POS (Point of Sale) interfaces, FDDIs (Fiber Distributed Data Interfaces) and the like. Generally, these interfaces may include ports appropriate for communication with the appropriate media. In some cases, they may also include an independent system including a processor and system memory.

The CPU 1702 may take various forms. It may include one or more general-purpose microprocessors that are selectively configured or reconfigured to implement the functions described herein. Alternatively, it may include one or more specially designed processors or microcontrollers that contain logic and/or circuitry for implementing the functions described herein. Any of the logical devices serving as CPU 1702 may be designed as general purpose microprocessors, microcontrollers (sometimes simply referred to as “controllers”), ASICs (application specific integrated circuits), DSPs (digital signal processors), PLDs (programmable logic devices), FPGAs (field programmable gate arrays), and the like. They may execute instructions under the control of the hardware, firmware, software, reconfigurable hardware, combinations of these, etc.

The hardware elements described above may be configured (usually temporarily) to act as one or more software modules for performing the operations of this invention. For example, separate modules may be created from program instructions for performing the functionality of the embodiments according to the present invention as described above. The components shown in FIG. 17 are coupled separately, but any or all of them may be coupled through a common system bus (e.g., a PCI bus). In appropriate cases, a part of the hardware elements in FIG. 17 can be omitted.

Although only a few embodiments of the present invention have been described in detail, it should be understood that the present invention may be embodied in many other specific forms without departing from the spirit or scope of the invention. Therefore, it should be apparent that the above described embodiments are to be considered as illustrative and not restrictive, and the invention is not to be limited to the details given herein.

What is claimed is:

1. A knowledge information extracting device comprising:
a first storing means for storing a type of information to be output with respect to a designated information processing device;
a second storing means for storing a type of information to be input with respect to the information processing device;
a knowledge information database access means capable of accessing a knowledge information database containing a plurality of rules, each of the rules including a condition part and a conclusion part;
a rule extracting means for extracting at least one rule having the condition part corresponding to the type of information to be input, and the conclusion part corresponding to the type of information to be output, by using the knowledge information database access means; and
a knowledge information storing means for storing the at least one rule extracted by the rule extracting means by associating the at least one rule with the information processing device.

2. A method for extracting knowledge information comprising:
storing a type of information to be output with respect to a designated information processing device;
storing a type of information to be input with respect to the information processing device;
accessing a knowledge information database containing a plurality of rules, each of the rules including a condition part and a conclusion part;
extracting at least one rule having the condition part corresponding to the type of information to be input, and the conclusion part corresponding to the type of information to be output, by using the knowledge information database; and
storing the at least one rule by associating the at least one rule with the information processing device.

3. A knowledge information setting device comprising:
a first storing means for storing a type of information to be output with respect to a designated information processing device;
a second storing means for storing a type of information to be input with respect to the information processing device;
a knowledge information database access means capable of accessing a knowledge information database containing a plurality of rules, each of the rules including a condition part and a conclusion part;
a rule extracting means for extracting at least one rule having the condition part corresponding to the type of information to be input, and the conclusion part corresponding to the type of information to be output, by using the knowledge information database access means;
a knowledge information storing means for storing the at least one rule extracted by the rule extracting means by associating the at least one rule with the information processing device; and
a knowledge transfer means for transferring the at least one rule stored in the knowledge information storing means to the information processing device through a communication network for setting the information processing device.

4. A method for setting knowledge information comprising:
storing a type of information to be output with respect to a designated information processing device;
storing a type of information to be input with respect to the information processing device;
accessing a knowledge information database containing a plurality of rules, each of the rules including a condition part and a conclusion part;
extracting at least one rule having the condition part corresponding to the type of information to be input, and the conclusion part corresponding to the type of information to be output, by using the knowledge information database;
storing the at least one rule by associating the at least one rule with the information processing device; and
transferring the stored at least one rule to the information processing device through a communication network for setting the information processing device.

5. A knowledge information request device, used in a network system including a plurality of information processing devices coupled by a communication path, for requesting extraction of knowledge information from a knowledge information database for setting each of the information processing devices, the knowledge information request device comprising:
a system stricture information generation means for generating system structure information capable of deriving at least a type of information to be input and a type of information to be output with respect to each of the information processing devices based on information from each of the information processing devices by communicating with the information processing devices; and
a means for transmitting the system structure information to a center device which contains a knowledge database access means, and for requesting transmission of knowledge information to be set to each of the information processing device from the center device.

6. A method of requesting knowledge information, used in a network system including a plurality of information processing devices coupled by a communication path, for requesting extraction of knowledge information from a knowledge information database for setting each of the information processing devices, the method comprising:
generating system structure information by deriving at least a type of information to be input and a type of information to be output with respect to each of the information processing devices based on information from each of the information processing devices by communicating with the information processing devices; and
transmitting the system structure information to a center device which contains a knowledge database access means, thereby requesting transmission of knowledge information to be set to each of the information processing device from the center device.

7. A method, used in a sensor network system including a plurality of information processing devices, each having a sensor, coupled by a communication path, for tuning a sensing model to be set to each of the plurality of the information processing devices, the method comprising:
receiving desired output data given externally for representing a desired output of the sensor network system;
recording output data output by the sensor network system, by associating the output data with the desired output data, and sensor output data of each of the plurality of the information processing devices when the desired output data is received;
transmitting the recorded output data and the recorded sensor output data to a center device by the sensor network system;
tuning the sensor model by the center device based on the recorded output data and the recorded sensor output data so that an evaluation function value with respect to an error between the desired output data, and the output data is minimized; and
downloading the tuned sensor model from the center device to corresponding each of the information processing devices in the sensor network system.

8. A system, used in a sensor network system including a plurality of information processing devices, each having a sensor, coupled by a communication path, for tuning a sensing model to be set to each of the plurality of the information processing devices, the system comprising:
means for receiving desired output data given externally for representing a desired output of the sensor network system;
means for recording output data output by the sensor network system, by associating the output data with the desired output data, and sensor output data of each of the plurality of the information processing devices when the desired output data is received;
means for transmitting the recorded output data and the recorded sensor output data to a center device by the sensor network system;
means for tuning the sensor model by the center device based on the recorded output data and the recorded sensor output data so that an evaluation function value with respect to an error between the desired output data, and the output data is minimized; and
means for downloading the tuned sensor model from the center device to corresponding each of the information processing devices in the sensor network system.

9. A system for monitoring a condition associated with at least one of a sensing object and a sensing area, comprising:
a plurality of sensor nodes, each of which being provided at a different location with respect to the at least one of the sensing object and the sensing area, and being capable of generating sensing data corresponding to the condition; and
a control unit capable of downloading a rule associated with the plurality of sensor nodes from a knowledge database containing the rule.

10. The system of claim 9, wherein the rule are represented based on at least one of a type of the at least one of the sensing object and the sensing area, a type of sensing information, and a type of output information type with respect to at least one of the plurality of sensor nodes.

11. A method for monitoring a condition associated with at least one of a sensing object and a sensing area, comprising:
providing a plurality of sensor nodes, each of which being provided at a different location with respect to the at least one of the sensing object and the sensing area, and being capable of generating sensing data corresponding to the condition; and
downloading a rule associated with the plurality of sensor nodes from a knowledge database containing the rule.

12. A system for monitoring a condition associated with at least one of a sensing object and a sensing area, comprising:
a plurality of sensor nodes, each of which being provided at a different location with respect to the at least one of the sensing object and the sensing area, and being capable of generating sensing data corresponding to the condition; and
a control unit capable of downloading a rule associated with the plurality of sensor nodes from a knowledge database containing the rule, and tuning a sensing model associated with each of the plurality of sensor nodes so that a desired output is obtained based on the rule and the sensing model.

13. A method for monitoring a condition associated with at least one of a sensing object and a sensing area, comprising:
providing a plurality of sensor nodes, each of which being provided at a different location with respect to the at least one of the sensing object and the sensing area, and being capable of generating sensing data corresponding to the condition;
downloading a rule associated with the plurality of sensor nodes from a knowledge database containing the rule; and
tuning a sensing model associated with each of the plurality of sensor nodes so that a desired output is obtained based on the rule and the sensing model.
